(19) United States
(12) Patent Application Publication
(10) Pub. No.: US 2007/0191532 A1
(43) Pub. Date: Aug. 16, 2007

(54) Method for preparing long glass fiber-reinforced composition and fabricated articles therefrom

(76) Inventors: Daniel De Kock, Assenede (BE); Norwin van Riel, Aardenburg (NL)

Correspondence Address: THE DOW CHEMICAL COMPANY, INTELLECTUAL PROPERTY SECTION,, P. O. BOX 1967, MIDLAND, MI, 48641-1967, US

(21) Appl. No.: 10/592,013

(22) PCT Filed: Mar. 15, 2005
(86) PCT No.: PCT/US05/08458

§ 371 Date: Sep. 7, 2006

Related U.S. Application Data
(60) Provisional application No. 60/553,659, filed on Mar. 16, 2004.

(51) Int. Cl. C08K 3/40

(52) U.S. Cl. 524/494; 524/548; 524/571; 524/502

(57) ABSTRACT

Process for production of a long fiber glass-filled ABS comprising (a) forming a long glass fiber master-batch by adding a long glass fiber to a high flow styrene-acrylonitrile (SAN) copolymer and (U) blending the master-batch with meat mass ABS resin. A molded article demonstrating High dimensional stability, good impact, strength anal heat performance is obtained.

### FIELD OF THE INVENTION

The present invention concerns a process for preparing a long fiber glass-filled thermoplastic composition and fabricated articles therefrom.

### BACKGROUND OF THE INVENTION

It is well known that the physical properties of thermoplastics can be improved by the incorporation of filler materials such as glass fibers. The incorporation of reinforcing fibers into polymeric products beneficially affects resin properties such as tensile strength, stiffness, dimensional stability and resistance to creep and thermal expansion. Traditional methods of producing such articles have been through use in standard, pre-compounded short fiber glass-filled ABS. While satisfying certain objectives in optimizing the quality of the finished product, conventional methods have proven to be commercially costly and in other ways have fallen short of their objectives in terms of density, impact performance and strength. A lower cost solution to the known methods of producing fiber-reinforced articles is desired.

Certain steps have been taken in overcoming the deficiencies of known methods by incorporating long glass fibers into thermoplastic material for producing a long fiber-reinforced thermoplastic article. See, WO 01/02471, titled LONG FIBER-REINFORCED THERMOSPLASTIC MATERIAL AND METHOD FOR PRODUCING THE SAME. According to this reference, long glass fibers are impregnated with a first thermoplastic material. The matrix of the material is composed of at least two different thermoplastics, thus enabling the fibers to be wet by one of the two thermoplastic materials. The resulting article demonstrates improved physical, chemical and electrochemical properties. However, while demonstrating an improvement in the state of technology, the process set forth in WO 01/02471 is burdened by the requirement to employ at least two thermoplastics for production of the glass fiber reinforced granulate.

Further, see, WO 0003852, titled GRANULES FOR THE PRODUCTION OF A MOLDING WITH A CLASS-A SURFACE, PROCESS FOR THE PRODUCTION OF GRANULES AND ITS USE. According to this reference, a granulate for the production of Class-A surface moldings is provided. The granulate comprises a thermoplastic polymer and long fiber material. The Fiber material is provided with lengths in the range of 1 to 25 mm. While also demonstrating an improvement in the state of technology, this reference is limited in its application to articles requiring Class-A surfaces and, furthermore, is limited by its inherent inability to achieve performance benefits realized through the use of amorphous polymers.

Further, see, U.S. Pat. No. 5,783,129, titled APPARATUS, METHOD, AND COATING DIE FOR PRODUCING LONG FIBER-REINFORCED THERMOPLASTIC RESIN COMPOSITION. According to this reference a method is disclosed for producing a long fiber-reinforced thermoplastic resin composition composed of a thermoplastic resin and fiber bundles. The preferred resins are selected from the group which includes semi-crystalline polymers like polyolefins, polyesters, and polyamides. See, U.S. Pat. No. 5,788,908 for METHOD FOR PRODUCING FIBER-REINFORCED THERMOPLASTIC RESIN COMPOSITION, is similar in that it too discloses a method for producing long fiber-reinforced thermoplastic resin composition. According to the disclosed method of production, a web-like continuous fiber bundle is impregnated with a thermoplastic resin melt to form a composite material. As with the preceding reference, the preferred resins are selected from the group which includes semi-crystalline polymers like polyolefins, polyesters, and polyamides. While these methods provide certain advantages over the prior art, the products produced by these methods are not able to demonstrate desired dimensional performance.

It would therefore be desirable to find an efficient and effective means of producing long glass fiber-reinforced articles that demonstrate lowered density, improved impact properties, improved strength properties, and superior dimensional stability as achieved with amorphous polymers but at reduced production costs.

### SUMMARY OF THE INVENTION

The present invention addresses the deficiencies of the art by providing a process for preparing a superior long glass fiber-reinforced composition for the production of a glass fiber-reinforced article of manufacture generally comprising:
(a) selecting a quantity of long glass fiber;
(b) adding the selected quantity of long glass fiber to a first copolymer to form a master-batch, the first copolymer being a high flow copolymer; and
(c) blending the master-batch with a second copolymer, the second copolymer being a stiffer flowing amorphous styrenic copolymer.

The first copolymer, the high flow copolymer, is preferably styrene-acrylonitrile (SAN), although other polymers may be used in addition to or in lieu thereof when forming a homogeneous blend with the stiffer flowing amorphous styrenic copolymer. The second copolymer, the stiffer flowing styrenic copolymer, is acryloniitrile-butadiene-styrene (ABS), although others may be used in addition to or in lieu thereof. The master-batch is preferably dry blended or is dosed by tile use of a mixing unit with the second styrenic copolymer.

### DETAILED DESCRIPTION OF THE INVENTION

The present invention provides a process for the preparation of a superior long fiber glass-filled thermoplastic composition for use in the production of a molder article that demonstrates high dimensional stability. The method for producing the composition of the present invention offers a low-cost approach to the production of a moldable compound having low density and high impact strength when compared to products produced by known methods.

The process of the present invention for the preparation of a fiber-reinforced product comprises the general steps of selecting a quantity of long glass fiber, adding the selected quantity of long glass fiber to a high flow of a first copolymer to form a master-batch, blending the master-batch with a second stiffer flowing styrenic copolymer to form an injection moldable or compression moldable glass fiber-reinforced resin compound, injecting the resin compound into a mold, and recovering a fiber-reinforced polymerized part.

The targeted fiber length in the master-batch is between 3.0 mm and 30.0 mm with an average length of about 15.0 mm. Long glass fibers or a plurality of glass strands bundled in the form of widely-used glass roving may be incorporated. Specific glass rovings may be used for particular applications. In any event, typically the glass fibers will be substantially uniform in length, with the length dependent upon the granule size of the long glass fiber master-batch.

The glass fibers are added to a flow of a carrier melt. The carrier is a high flow copolymer which provides sufficient wetting and reduced shear forces on the glass fibers to avoid uncontrolled sizing but sufficient dispersion. The carrier material is a high flow version of, or forms a homogeneous mixture with, the second stiffer flowing unreinforced amorphous unfilled material. The carrier may consist of either amorphous or functionalized semi-crystalline materials or blends thereof. Preferably the carrier is a styrene-actylonitrile (SAN) such as Tyril® (trademark, The Dow Chemical Company) or acrylonitrile-butadiene-styrene (ABS) such as MAGNUM® (trademark The Dow Chemical Company) or a styrene-maleic anhydride (SMA) such as DYLARK® (trademark, Arco Chemical Company). As a variation to the use of a styrenic-based carrier, alternate high flow versions engineering thermoplastic resins may be used or blended with the styrenic-based carrier such as polycarbonate (PC) such as CALIBRE® (trademark, The Dow Chemical Company) or a thermoplastic polyurethaine such as ISOPLAST° (trademark, The Dow Chemical Company).

Although there are alternative methods for adding the glass fibers to the carrier flow, the glass fiber may be added to the high flow carrier melt by way of a side feeder of the compounding unit. Preferably, the glass fiber is added to the high flow carrier melt in such an amount so that sufficient wetting and dispersion is achievable. A glass fiber concentration of 80 percent is possible but may provide a high vulnerability to poor dispersion. The preferred quantity of glass fibers is added to the first copolymer in such an amount so that the resulting master-batch has a glass fiber concentration of between about 40 percent and about 75 percent. The overall objective is to provide as high a concentration of glass fiber as possible while minimizing poor dispersion.

Once the master-batch is formed, it is dry-blended with the stiffer flowing unreinforced, second amorphous copolymer. Preferably, the second unreinforced amorphous material is a styrenic copolymer Such as an acrylate styrene acrylonitrile (ASA), ABS, SMA or alloys of these copolymers such as PC/ASA, PC/ABS, or PC/SMA. This neat polymer will contribute to the strength and heat of the final blend. By use of the master-batch concept, the high level performance of the second polymer is not compromised with additional material characteristics as required for a high dosing level LG fiber reinforcing process.

The addition level of the master-batch is between about 10 percent and about 40 percent depending on the required stiffness and dimensional performance of the final article.

The resulting dry blend is injected molded under standard injection conditions for the second non-reinforced polymer into a mold. The resulting glass fiber-reinforced article is thereafter removed from the mold.

A broad variety of additives may be included in the thermoplastic resins set forth above according to the specific applications and use of the resin composition. Such additives may include one or more of colorants, de-molding agents, anti-oxidants, UV stabilizers or inorganic fillers.

In general, a fiber-reinforced molded article produced according to the method for the present invention achieved several unexpected results. Of these results it was found that fewer glass fibers were needed to obtain a similar heat performance when compared with articles prepared according to known methods. It was also found that the resulting article had lower density and reduced weight when compared with such articles. Furthermore, the resulting article demonstrated improved impact performance, strength levels and heat resistance (at equivalent levels of stiffness) over articles produced according to known methods.

The process of the present invention is illustrated by the following practical example and comparative testing wherein all parts and percentages are by volume unless otherwise specified.

### PRACTICAL EXAMPLE

A long glass fiber master-batch is prepared using glass roving added, via a pultrusion or co-extrusion process, into a high flow SAN melt. The obtained glass fiber content in the master-batch was between 55 percent and 60 percent. This master-batch was dry-blended with several neat mass ABS resins in blending ratios between 15 percent and 35 percent. The dry-blend was used for molding articles in an injection molding machine under standard ABS conditions into an ISO test specimen.

### COMPARATIVE TESTING

The table below shows the obtained physical properties for three different dry blends prepared in accordance with the practical example set forth above with the exception of specified variations in glass levels in the master-batch and targeted glass fiber levels. Comparisons were made with a commercially available 16 percent short glass fiber containing ABS (Reference 1) compound and a commercially available 17 percent short glass fiber containing ABS (Reference 2).

| | | | Sample 1 | Sample 2 | Sample 3 | | |
|---|---|---|---|---|---|---|---|
| | | | MAGNUM ® | MAGNUM ® | MAGNUM ® | Reference | Reference |
| | Load | neat ABS grade | 3404 | 3404 | 3416 | 1 | 2 |
| Norm | Unit | Addition [v] LFG MB | 26% | 35% | 30% | 0 | 0 |
| | | Targeted Glass [v] | 15% | 20% | 17% | 16% | 17% |
| | kg/l | Density | 1.145 | 1.191 | 1.16 | 1.16 | 1.17 |
| | % | Ash content | 13.8 | 19 | 16 | 16 | |
| ISO 178 | MPa | Flex. mod. (regr. | 5279 | 5910 | 6201 | 5519 | 4700 |
| | | 0.05-0.25%) | | | | | |
| ISO 178 | MPa | Flex strength | 134 | 145 | 150 | 103 | 90 |
| ISO 527-2 | MPa | Tensile yield | 88 | 99 | 99 | 74 | 65 |
| ISO 527-2 | % | Elongation at rupture | 2.3 | 1.9 | 2.1 | 1.7 | |
| ISO 527-2 | MPa | Regr. modulus | 4810 | 6200 | 5857 | 5575 | 5100 |
| | | (0.05-0.25%) | | | | | |
| ISO 179/1f | kJ/m² | Unnotched Charpy | 23.2 | 22.8 | 24.5 | 18 | |
| | | impact 23° C. | | | | | |
| ISO 179/1c | kJ/m² | Notched Izod impact | 14.2 | 14.6 | 14.2 | 6 | 7 |
| | | 23° C. | | | | | |
| ISO 75A | ° C. | HDT 1.8 MPa | 104 | 119 | 109 | 102 | 96 |
| ISO 306 | ° C. | Vicat 50° C./hr 5 kg | 106 | 110 | 113 | 106 | 101 |
| ISO6603-2 | J | Total energy | 8.5 | 8.8 | 8.2 | 4.6 | |

“Magnum” is a registered trademark of The Dow Chemical Company.

As the comparative results illustrate, the articles produced according to the composition and method of the present invention demonstrate superior qualities in several areas, including reduced density, increased modulus, increased strength, improved notched impact strength and practical toughness and improved heat resistance.

It is understood that the above are merely preferred embodiments and that various changes and alterations can be made without departing from the spirit and broader aspects of the invention.

1. A method for producing a long glass fiber-reinforced thermoplastic resin composition, the method comprising the steps of:
selecting a quantity of long glass fiber having a length of 3.0 mm to 30 mm;
adding the selected quantity of long glass fiber to a first styrenic copolymer to form a master-batch, said first styrenic copolymer being a high flow copolymer; and
blending the master-batch with a second copolymer comprising a stiffer flowing amorphous styrenic copolymers.

2. The method in accordance with claim 1 wherein said first styrenic copolymer is selected from the group consisting of styrene-acrylonitrile (SAN), acrylonitrile-butadiene-styrene (ABS), and an alloy of ABS resins.

3. The method in accordance with claim 1 wherein the second copolymer is selected from the group consisting of acrylonitrile-butadiene-styrene (ABS), styrene-maleic anhydride (SMA), acrylate styrene acrylonitrile (ASA), PC/ASA, PC/ABS, and PC/SMA.

4. The method in accordance with claim 1 wherein the second copolymer blends with the first copolymer to form a homogeneous blend.

5. The method in accordance with claim 1 wherein the selected quantity of glass fibers is added to the first copolymer.

6. The method in accordance with claim 5 wherein the selected quantity of glass fibers is added to the first copolymer in such an amount so that the resulting master-batch has a glass fiber concentration of between 40 percent and 75 percent.

7. The method in accordance with any one of claim 1 wherein the blending ratio of the masterbatch with the second copolymer is between 10 and 40 percent about 10 percent and 40 percent.

8. The method in accordance with claim 1 wherein the long glass fiber is glass roving.

9. The method in accordance with claim 7 wherein the master-batch is dry-blended with the second copolymer.

10. The method in accordance with claim 1 wherein the second copolymer is a neat mass acrylonitrile-butadiene-styrene (ABS) resin.

11. A glass fiber-reinforced thermoplastic resin composition comprising:
glass fiber having a length of 3.0 mm to 30 mm;
a first styrenic copolymer, comprising a high flow copolymer selected from the group consisting of styrene-acrylonitrile (SAN), acrylonitrile-butadiene-styrene (ABS), an alloy of ABS resins and a polycarbonate; and
a second styrenic copolymer having stiffer flow properties selected from the group consisting of acrylonitrile-butadiene-styrene (ABS), styrene-maleic anhydride (SMA), arylate styrene acrylonitrile (ASA), PC/ASA, PC/ABS, and PC/SMA.

12. The glass fiber-reinforced thermoplastic resin composition of claim 11 wherein said glass fiber is glass roving.

13. The glass fiber-reinforced thermoplastic resin composition according to claim 12 wherein said second styrenic copolymer is a neat mass acrylonitrile-butadiene-styrene (ABS) resin.
